(19) United States
(12) Patent Application Publication
(10) Pub. No.: US 2012/0211964 A1
(43) Pub. Date: Aug. 23, 2012

(54) FOLDABLE BICYCLE WITH A LARGE WHEEL AND A SMALL WHEEL

(76) Inventors: Ming-Hung Cheng, Taipei City (TW); Li-Chieh Cheng, Taipei City (TW)

(21) Appl. No.: 13/369,298

(22) Filed: Feb. 9, 2012

(30) Foreign Application Priority Data
Feb. 18, 2011 (TW) 100203024
Jul. 10, 2011 (TW) 100212650

(51) Int. Cl. B62K 15/00

(52) U.S. Cl. 280/287

(57) ABSTRACT

A foldable bicycle with a large wheel and a small wheel contains an upper rod including one end connected with a side of a supporting post and another end coupled with a first tubular member, the first tubular member including a through hole; an axial shaft inserted into the through hole of the first tubular member of the upper rod and rotating in the through hole; the axial shaft also inserted into an orifice of a second tubular member of a lower rod and rotating in the orifice; wherein the axial shaft includes a bracket extending downward therefrom; the small wheel is axially disposed on a distal end of the bracket, and the large wheel is axially disposed on a distal end of a rear support; when the axial shaft rotates 180 degrees rearward, the small wheel is moved to be close to the large wheel.

### BACKGROUND OF THE INVENTION

1. Field of the Invention

The present invention relates to a foldable bicycle, and more particularly to a foldable bicycle with a large wheel and a small wheel.

2. Description of the Prior Art

A conventional foldable has a front wheel and a rear wheel, but diameters of the front and the rear wheels are small in the same size, so the rider rides laboriously but at slow speed.

Moreover, the diameters of the front wheel and the rear wheel of the conventional bicycle have to be decreased so as to lower a folding size, however, the rotating speed is also decreased to spend the rider more time and physical strength. Likewise, a constriction of the conventional foldable bicycle is complicated, so the production cost is high and the rider has to fold the foldable bicycle at inefficient time. If this conventional foldable bicycle is provided with an auxiliary power, such as a battery, it can not be folded effectively in a small size, and because the diameters of the front wheel and the rear wheel are the same, the riders has to ride the bicycle at high electricity consumption of the battery.

The present invention has arisen to mitigate and/or obviate the afore-described disadvantages.

### SUMMARY OF THE INVENTION

The primary object of the present invention is to provide a foldable bicycle in which a diameter of the small wheel is less than that of the large wheel, the gravity of the rider is close to the large wheel, the gravity of the small wheel is lowered to save effort. Also, the diameter of the large wheel is equal to that of the wheel of common bicycles, a riding speed of the foldable bicycle is higher than that of the conventional foldable bicycles and is equal to that of the common bicycles, enhancing riding efficiency. Furthermore, the foldable bicycle is assembled and disassembled easily, and the folding size of the foldable bicycle is decreased greatly to be stored conveniently. And when the axial shaft rotates 180 degrees rearward, the small wheel is folded below the first gear easily, and the handle holder, the first handle, and the second handle are moved to be close to the seat, thus folding the foldable bicycle in a small size.

Further object of the present invention is to provide a foldable bicycle in which the aperture of the handle holder includes a steel rope fixed therein, and two ends of the steel rope are connected with the first handle and the second handle individually so that after the first handle and the second handle are disassembled, they are connected together and hanged on the two ends of the handle holder by using the steel rope without falling.

Another object of the present invention is to provide a foldable bicycle which contains a hub motor and a power set; the hub motor is fixed on an axle center of the large wheel, and a mount is disposed on the upper end of the rear support and under the seat and has a receiving space to place the power set; wherein the power set is a battery; the power set is electrically connected with the hub motor so that the power set supplies power to the hub motor, hence an axle center of the hub motor is driven by the power to actuate the large wheel to rotate, and when the large wheel rotates, the small wheel rotates relative to the large wheel to provide an auxiliary power during riding, such that a rider rides the foldable bicycle at easy effort.

To obtain the above objective, a foldable bicycle provided by the present invention contains:

a large wheel disposed on a rear side thereof and a small wheel fixed on a front side thereof, and a diameter of the small wheel being less than that of the large wheel;

an upper rod including one end connected with a side of a supporting post and another end coupled with a first tubular member, the first tubular member including a through hole;

an axial shaft inserted into the through hole of the first tubular member of the upper rod and rotating in the through hole;

the axial shaft also inserted into an orifice of a second tubular member of a lower rod and rotating in the orifice; wherein

the axial shaft includes a bracket extending downward therefrom;

the small wheel is axially disposed on a distal end of the bracket, and the large wheel is axially disposed on a distal end of a rear support;

the axial shaft is in connection with a front fork, the front fork includes a handle holder fixed on a distal end thereof;

the handle holder of the front fork of the foldable bicycle includes an aperture to insert the first handle and the second handle into two ends of the aperture individually;

when the axial shaft rotates 180 degrees rearward, the small wheel is moved to be close to the large wheel.

### BRIEF DESCRIPTION OF THE DRAWINGS

FIG. 1 is a perspective view showing the assembly of a foldable bicycle according to a preferred embodiment of the present invention;

FIG. 2 is a perspective view showing the exploded components of the foldable bicycle according to the preferred embodiment of the present invention;

FIG. 3 is a partial amplified view showing the exploded components of the foldable bicycle according to the preferred embodiment of the present invention;

FIG. 4 is a partial amplified view showing the operation of the foldable bicycle according to the preferred embodiment of the present invention;

FIG. 5 is another partial amplified view showing the operation of the foldable bicycle according to the preferred embodiment of the present invention;

FIG. 6 is a perspective view showing the operation of the foldable bicycle according to the preferred embodiment of the present invention;

FIG. 7 is another perspective view showing the operation of the foldable bicycle according to the preferred embodiment of the present invention;

FIG. 8 is a plan view showing the assembly of a foldable bicycle according to another preferred embodiment of the present invention;

FIG. 9 is a perspective view showing the assembly of the foldable bicycle according to another preferred embodiment of the present invention;

FIG. 10 is a perspective view showing the operation of the foldable bicycle according to another preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

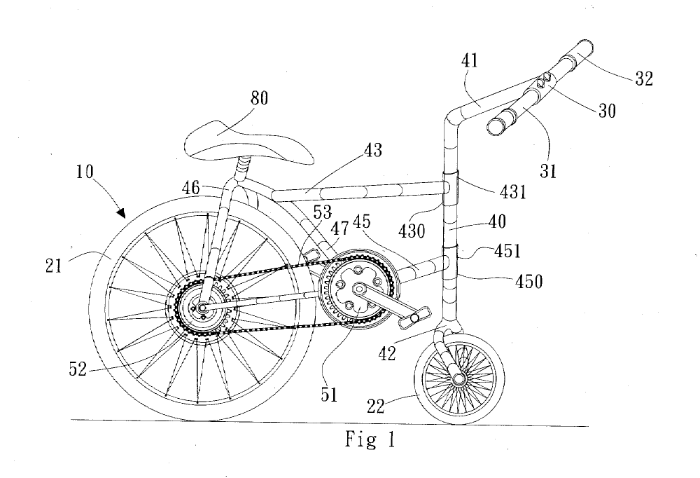

With reference to FIG. 1, a foldable bicycle 10 comprises a large wheel 21 and a small wheel 22; the large wheel 21 is axially disposed on a distal end of a rear support 46, an axial shaft 40 includes a bracket 42 extending downward therefrom, the small wheel 22 is axially disposed on a distal end of the bracket 42, and the rear support 46 includes a seat 80 arranged on a top surface of an upper end thereof; a supporting post 47 includes one end connected with a side of the upper end of the rear support 46 and another end including a first gear 51 coupled therewith, the first gear 51 includes a chain 53 disposed therearound, the chain 53 also engages with a second gear 52 of the large wheel 21; an upper rod 43 including one end connected with a proper position of a side of the supporting post 47 and another end coupled with a first tubular member 430, the first tubular member 430 includes a through hole 431 to be provided to insert the axial shaft 40 and to limit the axial shaft 40 on a front side of the foldable bicycle 10, and the axial shaft 40 is rotatable in the through hole 431; wherein the axial shaft 40 is in connection with a front fork 41, the front fork 41 includes a handle holder 30 fixed on a distal end thereof to insert a first handle 31 and a second handle 32 into two ends respectively; the axial shaft 40 is inserted into an orifice 451 of a second tubular member 450 of a lower rod 45 and includes the bracket 42 extending downward therefrom, the small wheel 22 is axially disposed on the distal end of the bracket 42, and the axial shaft 40 is rotatable in the orifice 451; wherein one end of the lower rod 45 is fixed on a positioning shank (not shown) of an axle center of the first gear 51; it is preferred that the first gear 51 is secured adjacent to a rim of the large wheel 21 to decrease a folding size of the foldable bicycle 10.

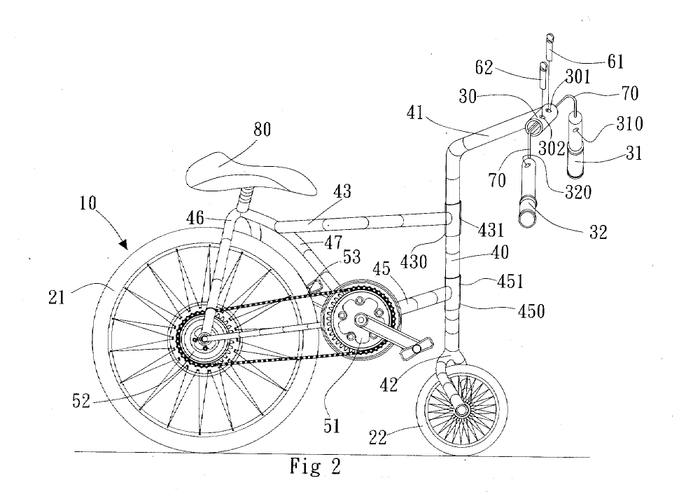

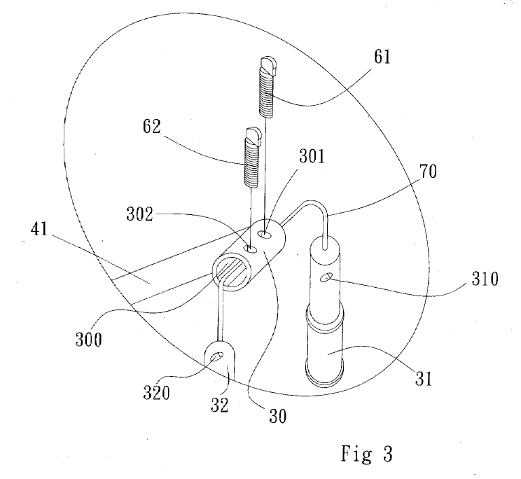

As shown in FIGS. 2 and 3, the handle holder 30 of the front fork 41 of the foldable bicycle 10 includes an aperture 300, and the first handle 31 includes a first bore 310 disposed on a peripheral side thereof, the second handle 32 includes a second bore 320 secured on a peripheral side thereof; wherein two ends of the aperture 300 of the handle holder 30 are provided to insert the first handle 31 and the second handle 32 individually, and the handle holder 30 includes a first opening 301 and a second opening 302 formed on two proper positions of an upper peripheral side thereof respectively; a first positioning member 61 is inserted into the first opening 301 and the first bore 310 of the first handle 31; a second positioning member 62 is inserted into the second opening 302 and the second bore 310 of the second handle 32 so that the first handle 31 and the second handle 32 are connected on two ends of the handle holder 30 individually; when the foldable bicycle 10 is not ridden, the first positioning member 61 and the second positioning member 62 are individually used to retract the first handle 31 and the second handle 32 easily, and the aperture 300 of the handle holder 30 includes a steel rope 70 fixed therein, and two ends of the steel rope 70 are connected with the first handle 31 and the second handle 32 individually so that after the first handle 31 and the second handle 32 are disassembled, they are connected together and hanged on the two ends of the handle holder 30 by using the steel rope 70 without falling; wherein the first positioning member 61 and the second positioning member 62 are a screw, a stud, or an inserting post so as to screw with or insert into the handle holder 30, hence the first handle 31 and the second handle 32 are fixed on the two ends of the handle holder 30 respectively, and the first bore 310 and the second bore 320 are a screw hole or a through hole.

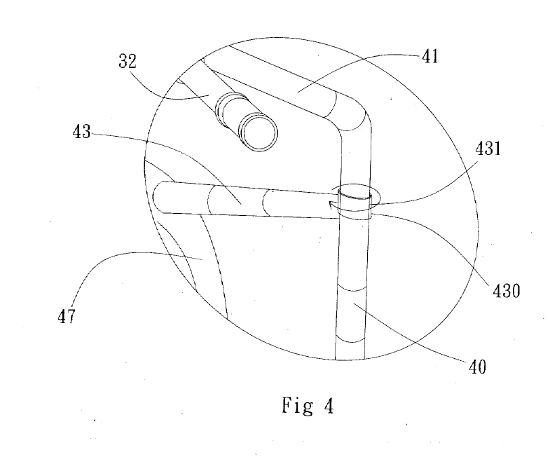

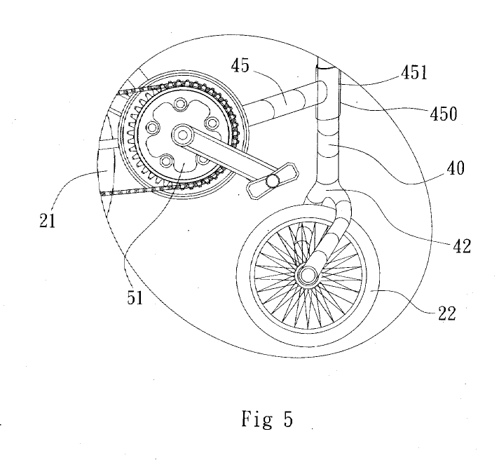

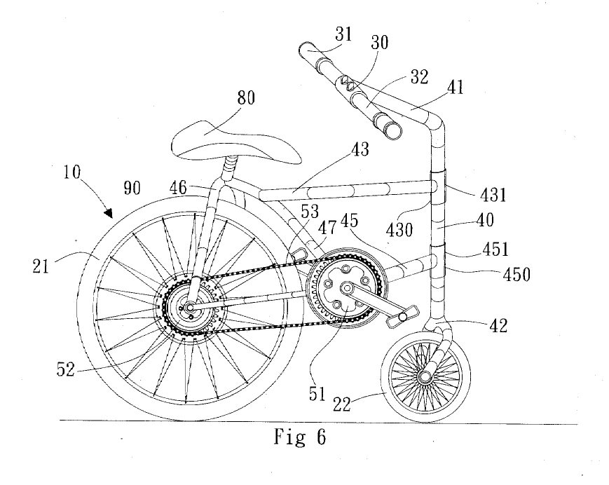

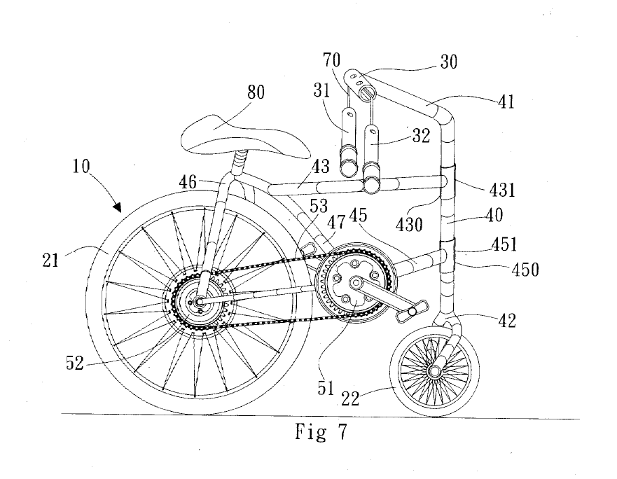

As illustrated in FIGS. 4-7, the axial shaft 40 of the foldable bicycle 10 is inserted into the through hole 431 of the first tubular member 430 of the upper rod 43 and the orifice 451 of the second tubular member 450 of the lower rod 45 so that the axial shaft 40 is limited on a front end of the foldable bicycle 10 and is rotatable in the through hole 431 and the orifice 451; when the axial shaft 40 rotates 180 degrees rearward, the small wheel 22 is folded below the first gear 51 easily, and the handle holder 30, the first handle 31, and the second handle 32 are moved to be close to the seat 80, thus folding the foldable bicycle 10 in a small size; wherein after disassembling the first positioning member 61 and the second positioning member 62, the first handle 31 and the second handle 32 are coupled together by ways of the steel rope 70 so that the first handle 31 and the second handle 32 are hanged on the two ends of the handle holder 30 individually, thereby retracting the foldable bicycle quickly and decreasing the folding size of the foldable bicycle.

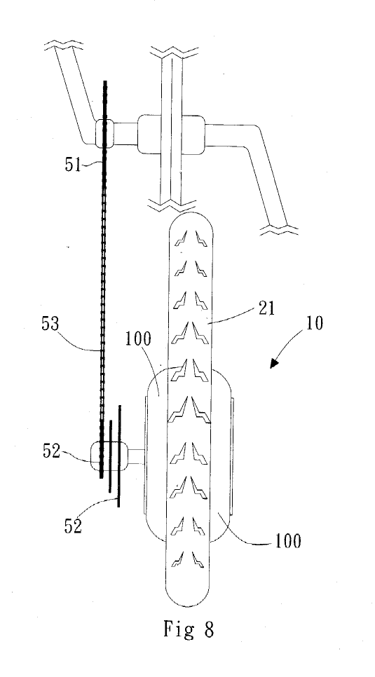

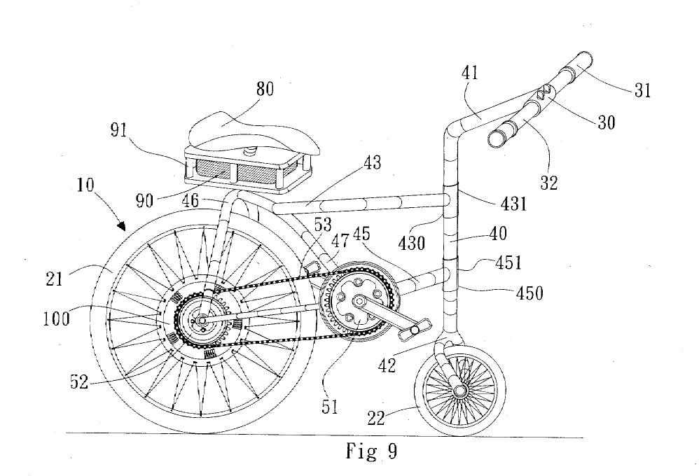

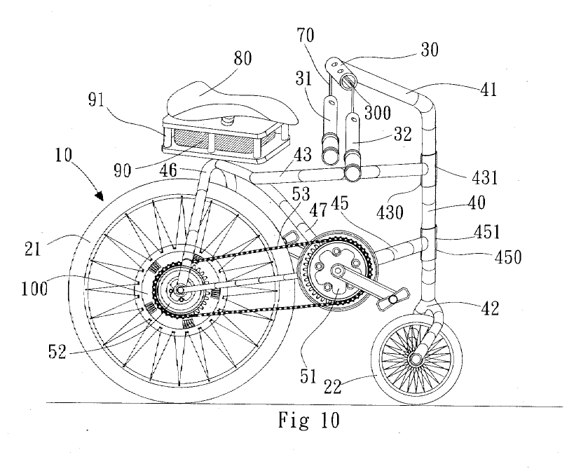

With reference to FIGS. 8-10, a foldable bicycle 10 according to another preferred embodiment of the present invention further comprises a hub motor 100 and a power set 90; the hub motor 100 is fixed on an axle center of the large wheel 21, and a mount 91 is disposed on the upper end of the rear support 46 and under the seat 80 and has a receiving space to place the power set 90; wherein the power set 90 is a battery; the power set 90 is electrically connected with the hub motor 100 so that the power set 90 supplies power to the hub motor 100, hence an axle center of the hub motor 100 is driven by the power to actuate the large wheel 21 to rotate, and when the large wheel 21 rotates, the small wheel 22 rotates relative to the large wheel 21 to provide an auxiliary power during riding, such that a rider rides the foldable bicycle at easy effort. In addition, when riding in the uphill, because a gravity of the rider is close to the large wheel 21, a gravity of the small wheel 22 is lowered to ride in the uphill easily. Also, the electricity consumption is decreased to prolong service life of the battery.

Thereby, the foldable bicycle of the present invention is assembled and disassembled easily, and the folding size of the foldable bicycle is decreased greatly to be stored conveniently. Due to a diameter of the small wheel is less than that of the large wheel, the gravity of the rider is close to the large wheel, the gravity of the small wheel is lowered to save effort. Also, the diameter of the large wheel is equal to that of the wheel of common bicycles, a riding speed of the foldable bicycle is higher than that of the conventional foldable bicycles and is equal to that of the common bicycles, enhancing riding efficiency.

While we have shown and described various embodiments in accordance with the present invention, it is clear to those skilled in the art that further embodiments may be made without departing from the scope of the present invention.

What is claimed is:

1. A foldable bicycle comprising a large wheel disposed on a rear side thereof and a small wheel disposed on a front side thereof, and a diameter of the small wheel being less than that of the large wheel;
an upper rod including one end connected with a side of a supporting post and another end coupled with a first tubular member, the first tubular member including a through hole;
an axial shaft inserted into the through hole of the first tubular member of the upper rod and being rotatable in the through hole;
the axial shaft also inserted into an orifice of a second tubular member of a lower rod and being rotatable in the orifice; wherein
the axial shaft includes a bracket extending downward therefrom;
the small wheel is axially disposed on a distal end of the bracket, and the large wheel is axially disposed on a distal end of a rear support;
the axial shaft is in connection with a front fork, the front fork includes a handle holder fixed on a distal end thereof;
the handle holder of the front fork of the foldable bicycle includes an aperture to insert the first handle and the second handle into two ends of the aperture individually;
when the axial shaft rotates 180 degrees rearward, the small wheel is moved to be close to the large wheel.

2. The foldable bicycle as claimed in claim 1, wherein the first handle includes a first bore disposed on a peripheral side thereof, the second handle includes a second bore secured on a peripheral side thereof; the handle holder includes a first opening and a second opening formed on an upper peripheral side thereof respectively; a first positioning member is inserted into the first opening and the first bore of the first handle; a second positioning member is inserted into the second opening and the second bore of the second handle so that the first handle and the second handle are connected on two ends of the handle holder individually.

3. The foldable bicycle as claimed in claim 1, wherein the aperture of the handle holder includes a steel rope disposed therein; and two ends of the steel rope are connected with the first handle and the second handle individually so that after the first handle and the second handle are disassembled, they are connected together and hanged on the two ends of the handle holder by using the steel rope.

4. A foldable bicycle comprising a large wheel disposed on a rear side thereof and a small wheel disposed on a front side thereof, and a diameter of the small wheel being less than that of the large wheel;
an upper rod including one end connected with a side of a supporting post and another end coupled with a first tubular member, the first tubular member including a through hole;
an axial shaft inserted into the through hole of the first tubular member of the upper rod and being rotatable in the through hole;
the axial shaft also inserted into an orifice of a second tubular member of a lower rod and being rotatable in the orifice; wherein
the axial shaft includes a bracket extending downward therefrom;
the small wheel is axially disposed on a distal end of the bracket, and the large wheel is axially disposed on a distal end of a rear support;
when the axial shaft rotates 180 degrees rearward, the small wheel is moved to be close to the large wheel.

5. The foldable bicycle as claimed in claim 1 further comprising a hub motor and a power set; the hub motor being fixed on an axle center of the large wheel, and the power set being electrically connected with the hub motor so that the power set supplies power to the hub motor, hence an axle center of the hub motor is driven by the power to actuate the large wheel to rotate, and when the large wheel rotates, the small wheel rotates relative to the large wheel to provide an auxiliary power during riding;
wherein a mount is disposed on an upper end of the rear support and under the seat and has a receiving space to place the power set.

6. The foldable bicycle as claimed in claim 4 further comprising a hub motor and a power set; the hub motor being fixed on an axle center of the large wheel, and the power set being electrically connected with the hub motor so that the power set supplies power to the hub motor, hence an axle center of the hub motor is driven by the power to actuate the large wheel to rotate, and when the large wheel rotates, the small wheel rotates relative to the large wheel to provide an auxiliary power during riding;
wherein a mount is disposed on an upper end of the rear support and under the seat and has a receiving space to place the power set.

7. The foldable bicycle as claimed in claim 5, wherein the power set is a battery.

8. The foldable bicycle as claimed in claim 6, wherein the power set is a battery.

9. The foldable bicycle as claimed in claim 1, wherein the supporting post includes one end connected with a side of the upper end of the rear support and another end including a first gear coupled therewith.

10. The foldable bicycle as claimed in claim 4, wherein the supporting post includes one end connected with a side of the upper end of the rear support and another end including a first gear coupled therewith.

11. The foldable bicycle as claimed in claim 9, wherein the first gear includes a chain disposed therearound, the chain also engages with a second gear of the large wheel.

12. The foldable bicycle as claimed in claim 10, wherein the first gear includes a chain disposed therearound, the chain is also fixed on a second gear of the large wheel.

13. The foldable bicycle as claimed in claim 11, wherein the first gear is secured adjacent to a rim of the large wheel to decrease a folding size of the foldable bicycle.

14. The foldable bicycle as claimed in claim 12, wherein the first gear is secured adjacent to a rim of the large wheel to decrease a folding size of the foldable bicycle.
